(19) United States
(12) Patent Application Publication
(10) Pub. No.: US 2024/0243461 A1
(43) Pub. Date: Jul. 18, 2024

(54) VEHICLE ANTENNA ADAPTED FOR MOUNTING TO A WINDOW SUCH AS A WINDSHIELD

(71) Applicant: Antenum, Inc., Merrimack, NH (US)

(72) Inventors: John T. Apostolos, Lyndeborough, NH (US); William Mouyos, Windham, NH (US)

(21) Appl. No.: 18/414,867

(22) Filed: Jan. 17, 2024

Related U.S. Application Data
(60) Provisional application No. 63/439,609, filed on Jan. 18, 2023.

(51) Int. Cl. H01Q 1/32; H01Q 1/48; H01Q 9/04; H01Q 21/06

(52) U.S. Cl. CPC H01Q 1/3275; H01Q 1/48; H01Q 9/0407; H01Q 21/065

(57) ABSTRACT

A low profile, planar, wide band (e.g., 600 MHz to 5 GHZ) antenna assembly consisting of four subarrays, each subarray consisting of a set of planar elements connected in a dipole. The elements may be disposed on a first layer or surface of a non-conductive substrate such as a printed circuit board. A second set of subarrays may also comprise planar elements disposed on a second layer of the substrate and operates as a GPS antenna. The elements on the second layer overlap somewhat with the elements on the first layer to provide a partial ground plane for the elements on the first later. A beamforming circuit may be coupled to the sub-arrays, depending on configuration. The assembly may be placed on a windshield or rear window of a vehicle, such as a passenger car near the roof.

### CROSS-REFERENCE TO RELATED APPLICATIONS

This patent application claims priority to a co-pending U.S. Provisional Patent Application Ser. No. 63/439,609 filed Jan. 18, 2023, the entire contents of which are hereby incorporated by reference.

### BACKGROUND OF THE INVENTION

This patent application is directed to the integration of a suite of antennas into a package that can operate in a free space installation such as on the windshield of a vehicle. More particularly, it pertains to a package that contains a low-profile antenna array that can operate across a wide range of frequencies, to cover from 600-6,000 MHz and to cover functions including 3G/4G/5G cellular including MIMO, Wi-Fi, Bluetooth, GNSS, and other functions.

Antennas have long been attached to and even embedded in certain portions of vehicles. One common approach implements distributed antennas as a conductive wire trace deposited onto a window. However, window antennas have drawbacks, such as reduced visibility out of the window, directional sensitivity, and degradation due to sun exposure over time and are costly to implement. So-called shark fin antennas have been in use since the late 1990's. These roof mounted assemblies, approximately 6 inches or so in length, are encased in an aerodynamic or other visually pleasing housing. However, shark fins protrude from the vehicle body and their shortened length sometimes to compromise reception, and require structural modifications to the vehicle to incorporate

A directional antenna formed of multiple radiating elements can provide a concentrated signal or beam in a selected direction to increase antenna gain and directivity. But since vehicle design is often dictated by styling, the presence of numerous protruding antennas is not desirable. Directional antenna arrays often have complex shapes and large size, making them difficult to package in a vehicle. These antennas also do not provide the required pattern coverage to work within the network constraints.

It is also preferable to conceal the antenna components to protect them from the elements and to preserve vehicle aesthetics. In order to conceal the antenna, it might be considered to be desirable to locate the radiating elements internal to the vehicle to eliminate noticeable protrusions.

Of interest are certain earlier patents and patent applications such as U.S. Pat. No. 10,903,574B2 entitled “Low profile antenna—conformal”, US20190348754A1 entitled “Smart antenna for in-vehicle applications that can be integrated with TCU and other electronics”, WO2021127095A1 entitled “Advanced conformal antenna with four omnidirectional beams” and U.S. Pat. No. 11,105,882 entitled “Orientation independent antennas with direction finding for remote keyless entry”,

### SUMMARY OF THE INVENTION

According to the teachings herein, a suite of antennas is implemented on a low-profile, planar substrate and attached to a glass surface of a vehicle such as on the windshield just above the rear-view mirror and just below the roof line. The assembly may incorporate a telematics control unit (TCU).

More specifically, radiating patch elements are arranged as a set of four antenna elements fed to achieve a modified dipole pattern on a forward facing, upper surface of a substrate. The elements may each consist for four planar elements that consist of sections of conductive material arranged in a two by two array. The four elements are arranged at 90 degrees with respect to each other. This configuration has each modified dipole pattern element in a null of the orthogonal element ensuring good decorrelation for the other elements in the structure. The dipole elements are dimensioned to provide operation in a selected functions such as LTE or 5G cellular, including operation in MIMO.

A second, overlapping lower surface of the substrate contains another set of radiating elements arranged to operate as a global navigation satellite systems (GNSS) antenna. The GNSS element is vertically aligned with and partially overlap the cellular elements on the other side. This enables the GNSS element to operate as a parasitic reflector for the cellular elements.

The angle of the windshield optimizes the radiation of, for example, Long Term Evolution (LTE) and/or Fifth Generation (5G) cellular band signals towards the front of the vehicle and maintains acceptable performance in other directions radiating in 360 azimuthal (AZ) degrees through the vehicle greenhouse. The single, small, flat assembly replaces multiple antenna structures that are commonly placed on the roof, side view mirrors, or dashboard of the vehicle.

WiFi/Bluetooth elements: These may be provided by modified dipole elements arranged at a 90 degree spacing and placed in the open spaces between LTE/5G/MIMO elements.

V2X elements: these can be provided by directional elements, such as cavity backed dipoles or monopoles, notches or horns.

### BRIEF DESCRIPTION OF THE DRAWINGS

Features and advantages of the approaches discussed herein are evident from the text that follows and the accompanying drawings, where:

FIG. 1 shows a preferred position of the antenna assembly on the front windshield of a passenger vehicle, above the rear view mirror and just below the roof line.

FIG. 2 is a view of the antenna assembly from within the vehicle, including a housing formed of a material such as plastic or other radio-transmissive material.

FIG. 3 shows the antenna arrays for operation in the LTE/5G band, disposed on the top surface of a planar substrate.

FIG. 4 shows the antenna arrays for operation in a Global Positioning System (GPS) band, disposed on the bottom surface of the planar substrate.

FIG. 5 illustrates the relatively alignment of the antenna arrays of FIGS. 3 and 4.

FIG. 6 is one possible driving circuit for the LTE/5G array.

FIG. 7 is an exploded view of an example cavity back V2X element.

### DETAILED DESCRIPTION

The antenna structures described herein are composed of a conformal, low-profile antenna assembly consisting of arrays of antenna elements disposed on a printed circuit board or other insulating substrate. In a preferred embodiment, the antenna assembly is placed within a housing that is mounted to one of the windows of a vehicle.

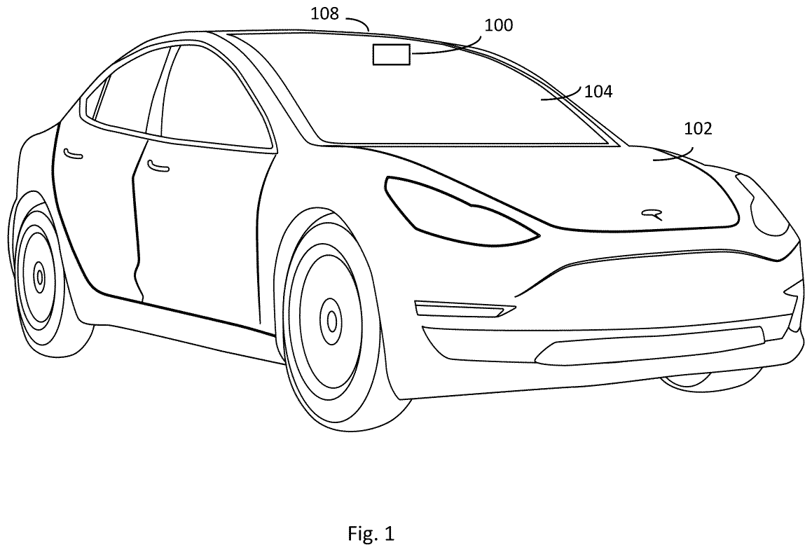

FIG. 1 shows an example of a mounting location for the antenna assembly 100 on a front windshield 104 of a passenger vehicle 102. The assembly 100 is preferably mounted on an upper portion of the windshield 104, near the vehicle roof 108.

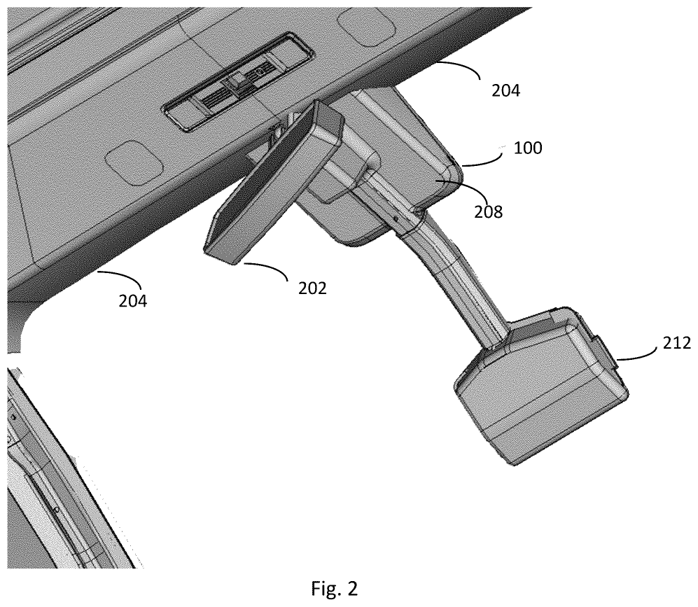

FIG. 2 is a more detailed view of the assembly 100 taken from inside vehicle 102, looking forward. This view shows a preferred location of the assembly 100, namely forward of a rearview mirror 202, and below one or more metallic roof section(s) 204. However it should be understood that the assembly 100 may be placed in other locations such as on a rear window or side window adjacent other metallic roof sections.

The assembly 100 consists of an enclosure 208 formed of a material such as Acrylonitrile Butadiene Styrene (ABS), polycarbonate or other polymer, fiberglass or other material that is transmissive to radio waves in most directions. Therefore, unlike other designs, this enclosure 208 does not provide a cavity with conductive walls. Rather, the enclosure is transmissive to radio waves in at least a forward and rearward direction of the vehicle for one or more of the desired operating frequency bands.

Other enclosures 212 may be mounted on or near the windshield 104 to enclose other devices such as rain sensors, wireless garage door actuators, and the like.

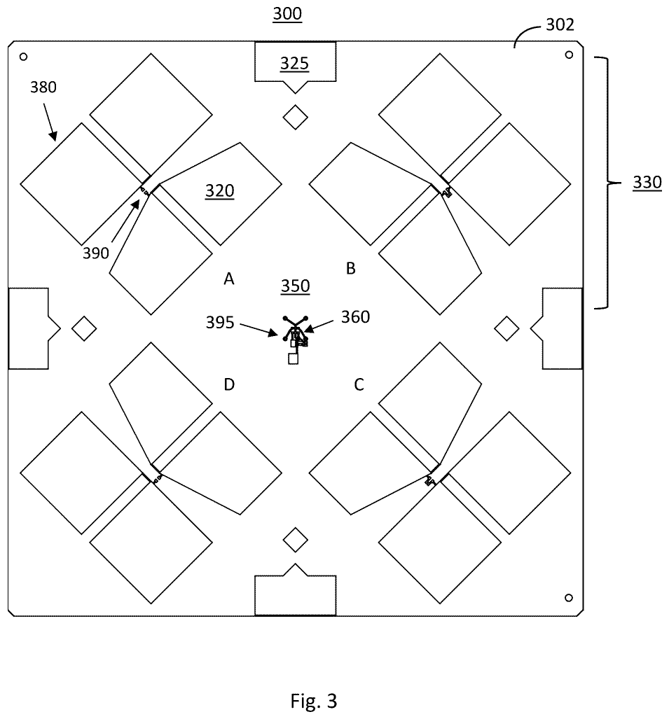

FIG. 3 shows a top surface 302 of a printed circuit board 300 that is contained within enclosure 208. The circuit board 300 contains a number of radiating antenna elements formed as planar conductive surfaces or other metallic radiating elements 320 on a first surface or layer 302 of the board 300. The printed circuit board 300 is disposed within the enclosure 208, typically with the sides of the board 300 parallel to the interior walls of the enclosure 208.

In this embodiment, there are sixteen (16) elements are arranged as four sub-arrays 330. Each sub-array 330 (A, B, C, D) thus consists of four elements 320. The elements 320 may be generally rectangular in shape. However there may be some tapering on some of the elements 320, which, if provided, provides increased bandwidth.

The elements 320 are also rotated by 45 degrees with respect to the sides of board 300. This leaves a central rectangular area 350 between the four sub-arrays, as well as triangular areas to the sides and corners of the board 300. The central rectangular area 350 provides a location within which may be placed a primary feed point 360. The primary feed point 360 is thus equidistant from each of the sub-arrays 330.

More particularly, each group of four elements (e.g., each sub-array 300) is arranged as a single dipole element 380. Thus, the elements 320 are shorted together in pairs to provide the two legs for each dipole. A connection point 390 is also located on or within each dipole 380, preferably near the center thereof, which is in turn connected to the central feed point 360 (that connection is not shown here, but understood to be provided within the circuit board 300.

In the preferred arrangement, each dipole 380 is decoupled from the other dipoles. This is accomplished, as shown, by placing each dipole within a null of exactly one another dipole. For example, dipole A is located at 180 degrees from dipole C and dipole B is located at 180 degrees from dipole D.

Given that the arrays 330 operate without a conductive cavity or other ground plane, when they are placed on a glass windshield as shown in FIGS. 1 and 2, they are effectively sitting in free space with the metallic roof sections acting as a partial ground plane.

A hybrid combiner circuit 395 may be placed at feed point 360. The hybrid combiner 395 may provide Circularly Polarized (CPOL) operation or other polarizations. Because the feed point 360 is located in the center of the assembly, such that each dipole connection 390 is equidistant from the feed point 360, phase matching is not needed.

The combiner circuit 395 can be arranged to connect the elements 320 in different configurations, such as to operate in different frequency bands depending on how the elements are connected together. For example, the array may operate in the LTE band in one configuration but in 5G bands with other combining network configurations. Examples of such combining networks are described in the above-listed patent applications that are hereby incorporated by reference.

Operation in the GNSS band may use a hybrid combiner disposed at the central feed point to 360 ensure good axial ratio and to not rely on phase matched cables leading to the a low noise amplified (LNA) circuit. The combiner can be configured to operate in the GNSS L1, L2, L5 bands (triband).

Passive matching structures 325 may be provided along the edges of the circuit board 300 to provide passive tuning to further assist with extending the operating range to, for example, cover a larger bandwidth across the LTE/5G range (such as from 600M-6.0 GHZ).

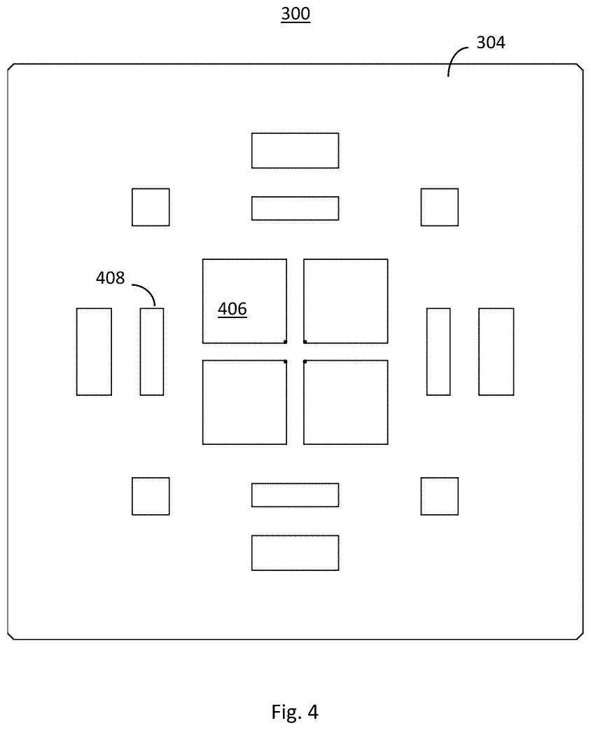

FIG. 4 is a view of another layer, such as the back side 304, of the printed circuit board 300. Four central radiating rectangular elements 406 each having a feed point 410 at an inboard corner thereof. Their dimensions may be selected to operate in a GNSS band. These elements 406 are also positioned with respect to the elements 320 on the front side so that elements 406 also operate as a partial ground plane for elements 320.

Other patches 408 may provide coupling with other elements on the front side 200.

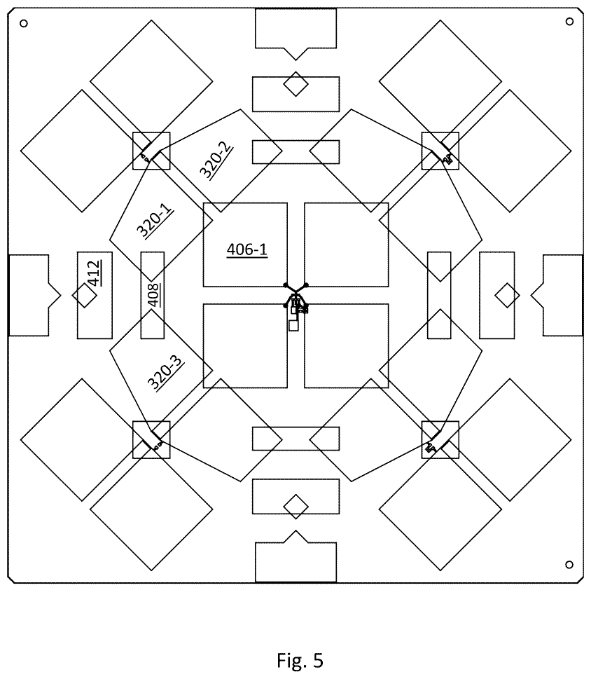

FIG. 5 is an overlay of the view of FIGS. 3 and 4 showing the juxtaposition of the patches on layers 302 and 304 this in more detail. GPS elements 406 provides a partial ground plane for elements 320-1, 320-2. GPS patch 406 also acts as a reflector for cellular elements 320-1, 320-2 so that the resulting pattern does not have as deep a null outward.

Element 408 provides a partial ground plane for elements 320-2 and 320-3.

Elements such as patch 412 may provide frequency dependent coupling to other patches and/or to the surrounding vehicle surfaces. These selective couplings are for tuning the structure across many different frequency bands.

This conformal, multi-nested array configuration can provide operation from, for example, 600 MHz to 5000 MHz. Hemispherical or monopole patterns can be provided as well as multiple and simultaneous antenna beams.

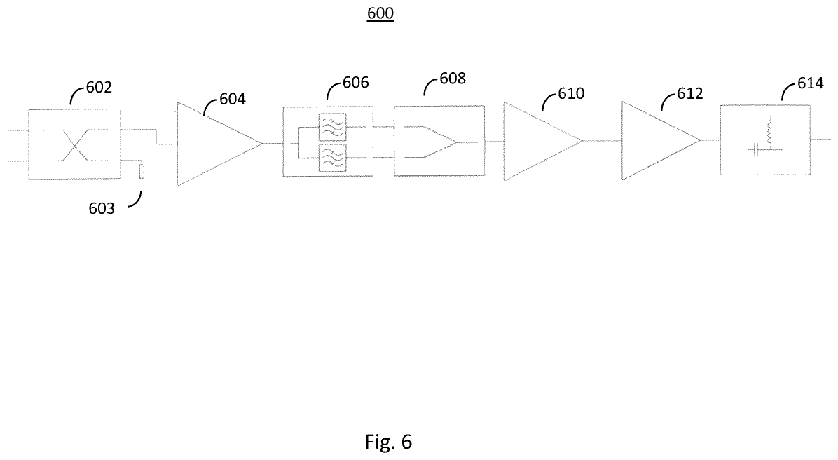

As explained above, the four dipoles can be fed through a combining or other beamforming network 395. An example of such a network 600 is shown in FIG. 6. A 90 degree hybrid 602 having termination 603 feeds a first low noise amplified (LNA) 604. The output of LNA 604 is fed to a L1/L2/L5 diplexer 602 to select the GNSS operating bands of interest. Power divider 608 feeds a pair of output amplifier stages 610, 612 and output bias tee 614.

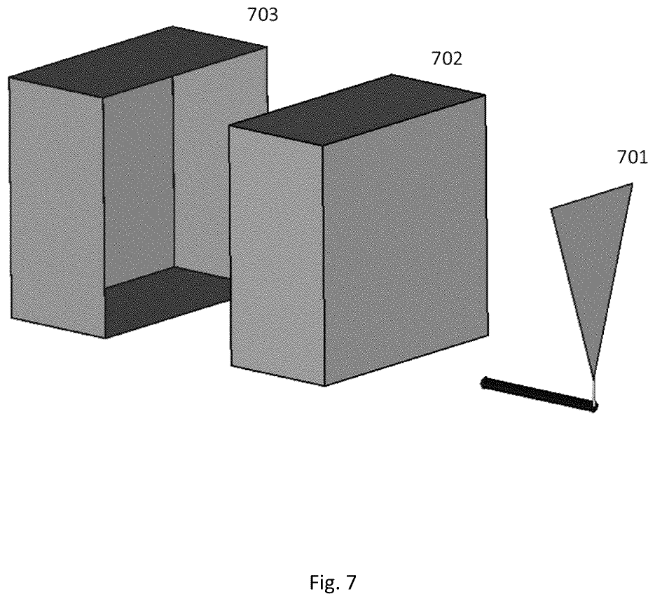

An example V2X element is shown in an exploded view of FIG. 7. The V2X element can be disposed with the other elements of the same structure as described above. The example V2X element here consists of a radiative dipole element 701 disposed on a dielectric substrate 702 backed by a cavity 703. Other configurations are possible such as notches or horns.

In other implementations, the array assembly may be embedded in a body panel such as a moonroof that is optically transparent. In that configuration, the radiative surfaces of the antenna elements may be formed of an optically transparent, conductive material such as Indium Tin Oxide (ITO), metal coated glass, graphene film or the like.

The antenna assembly may be scaled to support other types of Radio Frequency (RF) communication at desired frequency bands. It may be desirable to create simultaneous, arbitrary beams on different frequency bands such as widely used 4G or 5G cellular, WiFi, GPS, or Bluetooth bands. As explained in the referenced patent applications, arrays of radiating elements may be configured with a separate beamforming network for each frequency band. Respective bandpass filters and splitters may be inserted in-line between the beamformers and the array elements.

The above description has particularly shown and described example embodiments. However, it will be understood by those skilled in the art that various changes in form and details may be made therein without departing from the legal scope of this patent as encompassed by the appended claims.

1. A low profile, planar, antenna apparatus comprising:
a substrate;
a first set of four subarrays, each subarray consisting of a group of patch elements disposed on a first surface or layer of the substrate, with the patch elements connected in a dipole to provide four dipoles, the four dipoles configured in pairs of two such that each dipole is located in a null of another one of the dipoles, the patch elements in the first set of four subarrays dimensioned to operate in a first frequency band; and
a second set of four patch elements disposed on a second surface or layer of the substrate, each one of the second set of four patch elements vertically disposed to provide a partial ground plane for a respective one of the first set of subarrays, and the second set of four patch elements dimensioned to operate in a second frequency band.

2. The apparatus of claim 1 wherein the patches in the first set of four subarrays are rotated such that at least one side of a selected patch in a given subarray is aligned at an angle less than 90 degrees with respect to an edge of the substrate, to thereby leave a central rectangular area of the substrate between the first set of four subarrays, and also to leave triangular areas to the sides and corners of the first set of four arrays.

3. The apparatus of claim 2 wherein the angle is 45 degrees.

4. The apparatus of claim 2 wherein a primary feed point is disposed within the central rectangular area.

5. The apparatus of claim 1 wherein the first frequency band is a cellular band and the second frequency band is a GPS band.

6. The apparatus of claim 1 wherein the substrate is disposed in a housing that is radio-transmissive on all sides, and wherein the housing is adapted to be disposed on a vehicle windshield adjacent to one or more metallic roof sections, such that the one or more metallic roof sections operate as a partial ground plane for at least one of the subarrays.
